(19) United States
(12) Patent Application Publication
(10) Pub. No.: US 2025/0044078 A1
(43) Pub. Date: Feb. 6, 2025

(54) TIRE TREAD DETECTION DEVICE AND TIRE TREAD DETECTION SYSTEM

(71) Applicant: SHENZHEN SMARTSAFE TECH CO.,LTD., Shenzhen, Guangdong (CN)

(72) Inventors: Wei ZHAN, Shenzhen, Guangdong (CN); Qingwei WANG, Shenzhen, Guangdong (CN); Shaoli GU, Shenzhen, Guangdong (CN)

(21) Appl. No.: 18/717,377

(22) PCT Filed: Nov. 9, 2022
(86) PCT No.: PCT/CN2022/130949

§ 371 Date: Jun. 6, 2024

(30) Foreign Application Priority Data
Apr. 22, 2022 (CN) 202210425013.8

(51) Int. Cl. G01B 11/22; G01M 17/02; G06T 7/521; G06V 20/62

(52) U.S. Cl. CPC G01B 11/22; G01M 17/027; G06T 7/521; G06V 20/625

(57) ABSTRACT

A tire tread detection device includes a main body. The main body is provided with a cavity, and a first opening and a second opening that are spaced along a first direction and are in communication with the cavity. The cavity is provided therein with a first camera module and a laser module, the first camera module is configured to capture a tire tread area of a tire to be measured through the first opening to obtain a tire tread image, and a laser line of the laser module passes through the second opening to reach the tire tread area of the tire to be measured to obtain depth data of the tire tread; a control assembly processes the obtained tire tread depth and image information of the tire tread and compares them with the original data to determine the wearing degree of the tire tread.

### CROSS REFERENCE TO RELATED APPLICATION

The present application is a National Stage Appl. filed under 35 USC 371 of International Patent Application No. PCT/CN2022/130949 with an international filing date of Nov. 9, 2022, designating the United States, and claims priority of a Chinese patent application, with application No. 202210425013.8, filed on Apr. 22, 2022 to CNIPA; the contents each of which are incorporated herein by reference.

### TECHNICAL FIELD

The present application relates to the technical field of tire tread detection, and more specifically to a tire tread detection device and a tire tread detection system.

### BACKGROUND

Tires are the load-bearing portion of a vehicle, and the condition of the tires, especially the degree of wearing of the tire tread, directly affects the performance, safety, and fuel consumption of the entire vehicle. Generally, the condition of a tire is determined by a size of the tire tread and the wearing condition of the tire tread.

The method for detecting the wearing condition of the tire tread generally adopts the method of visual observation by a maintenance worker to observe whether the tire tread is complete. This method relies on human experience to determine, and human factors are significant, which cannot guarantee the detection accuracy. Another method is to use contact measurement by an inspector to measure the depth of the tire tread, since the operating methods of the inspector and the inherent errors in dimensions of the depth of the tire tread, the measured data may have significant errors, and manual detection efficiency is low; which is unsuitable for large-scale vehicle detection during vehicle annual inspection. There is no device in the relevant technology that can quickly and accurately detect the integrity and depth of tire tread simultaneously, so as to determine the wearing degree of the tire tread, which results in low efficiency, poor accuracy, and waste of manpower in wearing detection of the tire tread.

### SUMMARY

One of objects of embodiments of the present application is to provide a tire tread detection device and a tire tread detection system, which aims to solve the problem that existing detection devices cannot simultaneously detect the integrity and depth of the tire tread, so as to comprehensively determine the wearing degree of the tire tread, which leads to low efficiency, poor accuracy, and waste of manpower in wearing detection of the tire tread.

In order to solve the above technical problems, the technical solutions adopted in embodiments of the present application are summarized as follows:

In a first aspect, a tire tread detection device is provided, which includes a main body mounted to a fixed surface, and the main body is provided with a cavity, a first opening, and a second opening; the second opening and the first opening are spaced along a first direction and are respectively in communication with the cavity; a detection assembly is arranged inside the cavity, and the detection assembly includes a first camera module and a laser module; the first camera module is configured to capture a tire tread area of a tire to be measured through the first opening to obtain a tire tread image, and a laser line of the laser module passes through the second opening to reach the tire tread area of the tire to be measured to obtain depth data of the tire tread; and a control assembly, in which the first camera module and the laser module are electrically connected to the control assembly, respectively; and the first direction is a forward direction of the tire to be measured corresponding to the vehicle.

In an embodiment, the tire tread detection device further comprises a reflective plate located within the cavity, the reflective plate is configured to reflect the laser line emitted by the laser module to illuminate the tire tread area of the tire to be measured.

In an embodiment, the reflective plate is located on a side of the laser module away from or adjacent to the first camera module.

In an embodiment, two detection assemblies are provided, and two cavities are provided correspondingly; the two detection assemblies and the two cavities are arranged in one-to-one correspondence, and the two cavities are symmetrically arranged relative to a vertical line of the first direction.

In an embodiment, the main body includes upper covers, lower covers, first brackets, and second brackets; one of the upper covers and one of the lower covers are interlocked to form one of the two cavities, each of the upper covers is provided with the first opening and the second opening, the first brackets and the second brackets are mounted inside the two cavities, each of the first brackets is provided with a first transparent window arranged corresponding to the first opening of each of the upper covers, and each of the second brackets is provided with a second transparent window arranged corresponding to the second opening of each of the upper covers.

In an embodiment, the tire tread detection device further includes:
a license plate recognition assembly, and an end of the license plate recognition assembly is connected to one of the lower covers, and an other end of the license plate recognition assembly is connected to another one of the lower covers; the license plate recognition assembly includes a second camera module configured to identify and record a license plate of the vehicle corresponding to the tire to be measured; and the second camera module is electrically connected to the control assembly.

In an embodiment, a lens of the second camera module is oriented in an opposite direction of the first direction and is located in a spatial area above a horizontal plane.

In an embodiment, the tire tread detection device includes triggering mechanisms, and each of the triggering mechanisms includes a switch module located within one of the cavities, and the main body is provided with a fifth opening in communication with the one of the cavities; the fifth opening, the first opening, and the second opening are arranged in intervals along the first direction, and a triggering end of the switch module extends out of the fifth opening.

In an embodiment, the tire tread detection device further includes slope frames, two ends of each of the lower covers is respectively provided with one slope frame, and a cross-sectional shape of a structure formed by two slope frames and the main body is an isosceles trapezoid.

In a second aspect, a tire tread detection system is provided, which includes the tire tread detection device above mentioned. The tire detection system includes a display terminal electrically connected to a control assembly.

The tire tread detection device of the present application is mounted on a fixed surface for use. When the vehicle to be measured moves forward along the first direction on the main body, the first camera module captures the tire tread area on the tire to be measured to obtain images; the laser module then emits a laser line to illuminate the tire tread area on the tire to be measured, so as to dynamically collect the depth information of the tire tread on the tire to be measured. The control assembly processes the obtained tire tread depth and image information of the tire tread and compares them with the original data to determine the wearing degree of the tire tread. The present application can complete the information collection work when the vehicle passes through, which greatly saves manpower and the detection efficiency and accuracy are high.

### BRIEF DESCRIPTION OF DRAWINGS

In order to explain the embodiments of the present application more clearly, a brief introduction regarding the accompanying drawings that need to be used for describing the embodiments of the present application or the prior art is given below; it is obvious that the accompanying drawings described as follows are only some embodiments of the present application, for those skilled in the art, other drawings can also be obtained according to the current drawings on the premise of paying no creative labor.

FIG. 1 is a perspective view of a tire tread detection device of an embodiment of the present application;

FIG. 2 is an enlarged view of a Part A in FIG. 1;

FIG. 3 is a cross-sectional view of FIG. 2;

FIG. 4 is an enlarged view of a Part B in FIG. 3;

FIG. 5 is an explosive perspective view of FIG. 2; and

FIG. 6 is an enlarged view of a Part C in FIG. 5.

In the drawings, reference signs are listed:
1—main body; 10—cavity; 101—first opening;
102—second opening; 11—upper cover; 12—lower cover; 110—first bracket; 111—second bracket; 112—first transparent window; 113—second transparent window; 14—second protective shell; 2—detection assembly; 20—first camera module; 21—laser module; 22—reflective plate; 3—license plate recognition assembly; 31—second camera module; 32—first protective shell; X—first direction; 1120—first sealing ring; 1130—second sealing ring; 4—triggering mechanism; 41—switch module; 400—fifth opening; 5—slope frame; 50—slope surface; I—sight line of camera; J—laser line; 6—control assembly; and 7—illustrative tire.

### DETAIL EMBODIMENTS OF INVENTION

In order to make the purpose, the technical solution and the advantages of the present application be clearer and more understandable, the present application will be further described in detail below with reference to accompanying figures and embodiments. It should be understood that the specific embodiments described herein are merely intended to illustrate but not to limit the present application.

It is noted that when a component is referred to as being “fixed to” or “disposed on” another component, it can be directly or indirectly on another component. When a component is referred to as being “connected to” another component, it can be directly or indirectly connected to another component. Terms such as “up”, “down”, “left”, “right” and so on are the directions or location relationships shown in the accompanying figures, which are only intended to describe the present application conveniently and simplify the description, but not to indicate or imply that an indicated device or component must have specific locations or be constructed and manipulated according to specific locations; therefore, these terms shouldn't be considered as any limitation to the present application. In addition, terms “the first” and “the second” are only used in describe purposes, and should not be considered as indicating or implying any relative importance, or impliedly indicating the number of indicated technical features. In the description of the present application. “a plurality of” means two or more, unless there is additional explicit and specific limitation.

In order to illustrate the technical solution described in the present application, the following is a detailed explanation combined with specific drawings and embodiments.

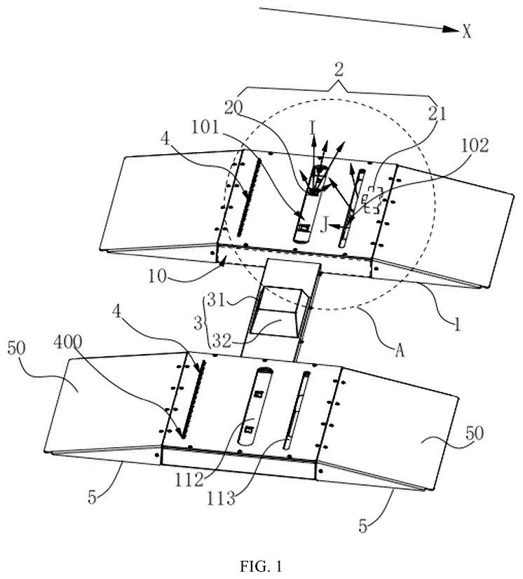

As shown in FIGS. 1 to 6, the tire tread detection device mentioned in the present application includes a main body 1, the main body 1 is generally mounted on a fixed surface (not shown). Specifically, the tire tread detection device of the present application is generally applied to fixed surfaces on a horizontal surface both indoors and outdoors.

Optionally, the fixed surfaces mentioned in the present application can be detection boards, speed bumps, etc., and in other embodiments, other types of fixed surfaces can also be used. Here, which will not be repeated herein. In the embodiment, there is no specific limitation on the specific material of the fixed surface, which can be steel, iron, concrete, etc.

In the embodiments, the device can also be directly mounted on a horizontal ground.

Definition explanation: The first direction (X) mentioned in the present application is the forward direction of the vehicle corresponding to the tire to be measured. Taking the example of the reader facing the accompanying drawings in the present application, the top direction is above the reader, and the bottom direction is below the reader, to explain the technical solution of the present application.

It can be known that the tire tread detection device of the present application does not require the vehicle to dismantle the tire for detection. Specifically, when the vehicle is driving on the device and passing through, the tire tread information of the tire to be measured is dynamically collected, and data analysis is carried out to determine the wearing degree of the tire tread.

In an embodiment, as shown in FIG. 1, the main body 1 is provided with a cavity 10, a first opening 101, and a second opening 102; the second opening 102 and the first opening 101 are spaced along the first direction (X). Moreover, the first opening 101 and the second opening 102 are respectively in communication with the cavity 10. Specifically, in this embodiment, both the first opening 101 and the second opening 102 are provided on the top sidewall of the cavity 10. That is, when the vehicle corresponding to the tire to be measured drives onto the main body 1, the first opening 101 and the second opening 102 are arranged facing the tire to be measured.

In an embodiment, as further shown in FIGS. 1 to 3, a detection assembly 2 is arranged inside the cavity 10, and the detection assembly 2 includes a first camera module 20 and a laser module 21. Specifically, the vehicle travels in the first direction (X) onto the main body, and the laser line (J) emitted by the laser module 21 passes through the second opening 102 to reach the tire tread area of the tire to be measured (i.e. the tire tread area corresponding to the second opening 102) to obtain the depth data of the tire tread. The first camera module 20 captures the tire tread area of the tire to be measured through the first opening 101 to obtain tire tread images, and synchronously transmits the tire tread images to the control assembly 6 for recording and analysis. Specifically, the control assembly combines test image data and depth data for simulated mapping, compares the simulated data with the original image data, and automatically determines the absence and cracking of tire treads in the tire tread area.

As shown in FIGS. 1 to 6, the technical solution of an embodiment in the present application is explained.

In an embodiment, two detection assemblies 2 are provided, and two cavities 10 are correspondingly provided; the two detection assemblies 2 and the two cavities 10 are arranged in one-to-one correspondence. It can be known that the two cavities 10 are arranged independently of each other, and the two cavities 10 are symmetrically arranged relative to a vertical line of the first direction (X). That is, the detection assemblies 2 inside the two cavities 10 are symmetrically arranged relative to the vertical line in the first direction (X), and the two detection assemblies correspond to a pair of left and right wheels in front of the vehicle or a pair of left and right wheels n back. Moreover, the two cavities 10 are symmetrically arranged in a plane where the fixed surface is located relative to the vertical line in the first direction (X), the plane can be understood as a horizontal plane.

In an embodiment, the distance between two cavities 10 is the distance between the left and right wheels of the vehicle.

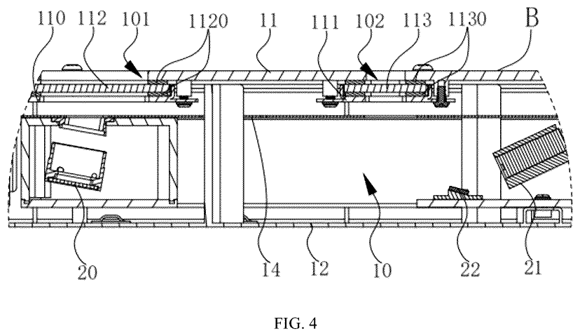

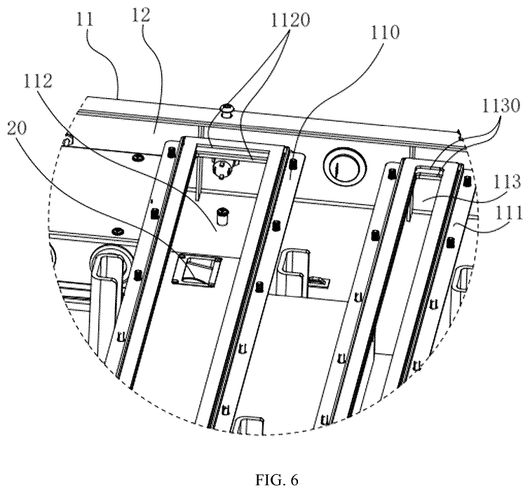

In an embodiment, as further shown in FIGS. 4 and 6, the tire tread detection device includes upper covers 11, lower covers 12, first brackets 110, and second brackets 111. One upper cover 11 and one lower cover 12 are interlocked to form one cavity 10. Each of the upper covers 11 is provided with a first opening 101 and a second opening 102. The inner wall of the one cavity 10 is provided with one first bracket 110 and one second bracket 111. The first bracket 110 is provided with a first transparent window 112 corresponding to the first opening 101 of the corresponding upper cover 11. The second bracket 111 is provided with a second transparent window 113 corresponding to the second opening 102 of the corresponding upper cover 11.

Specifically; the first bracket 110 and the second bracket 111 are mounted onto the inner wall of the upper cover 11; alternatively, the first bracket 110 and the second bracket 111 are mounted onto the inner wall of the lower cover 12.

In an embodiment, as further shown in FIGS. 4 and 6, the tire tread detection device further includes a first sealing ring 1120 and a second sealing ring 1130. The gap between the upper cover 11 and the first bracket 110, as well as the gap between the first transparent window 112 and the first bracket 110, are all provided with the first sealing ring 1120 for dust and water prevention.

Moreover, the gap between the upper cover 11 and the second bracket 111, as well as the gap between the second transparent window 113 and the second bracket 111, are all provided with the second sealing ring 1130 for dust and water prevention.

In an embodiment, as shown in FIGS. 1, 3, and 5, the tire tread detection device further includes slope frames 5, and each lower cover 12 is provided with one slope frame 5 at both ends along the first direction (X). Moreover, the cross-sectional shape of a structure formed by the two slope frames 5 and the main body 1 is an isosceles trapezoid. Two slope frames 5 serve as auxiliary climbing structures for vehicle travelling. In an embodiment, the smaller the angle between the slope surface 50 of each of the two slope frames 5 and the fixed surface, the better.

In other embodiments, the cross-sectional shapes of the structure formed by the two slope frames 5 and the main body 1 in the embodiment can also be other shapes, which will not be listed one by one here. It should be noted that the surface of the structure formed by the two slope frames 5 and the main body 1 in the embodiment can be a flat or curved surface, and which is not limited herein.

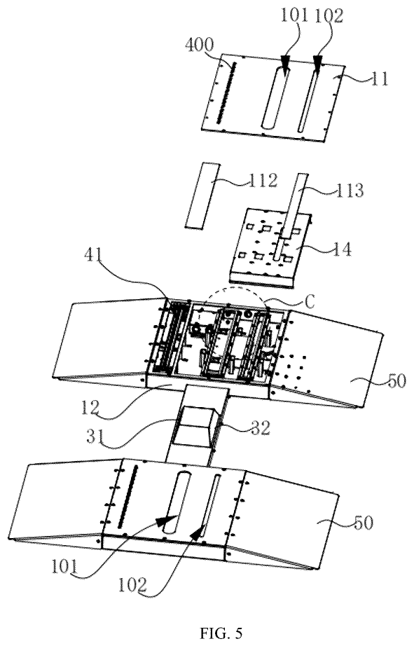

In an embodiment, as further shown in FIGS. 1 and 5, the tire tread detection device further includes a license plate recognition assembly 3, and an end of the license plate recognition assembly 3 connected to one lower cover 12 and the other end connected to another lower cover 12. That is, the license plate recognition assembly 3 is mounted on the main body 1 and is located between two detection assemblies 2, but on the outside of the cavity 10. It can be known that when the device is used indoors, the maximum width of the entire device needs to correspond to the distance between the left and right tires of the vehicle. The license plate recognition assembly 3 mounting between two detection assemblies 2 will correspondingly reduce the footprint of the device.

In the embodiment, specifically, the license plate recognition assembly 3 includes a second camera module 31; when the vehicle is travelling in the first direction (X), the second camera module 31 is arranged in the opposite direction of the first direction (X) and is located in a spatial area above the horizontal plane. It can be known that the license plate of the vehicle is at a certain height from the ground (fixed surface), so that the second camera module 31 is arranged obliquely. The second camera module 31 is configured to identify and record the brand of the vehicle corresponding to the tire to be measured, and is electrically connected to the control assembly 6.

As further shown in FIGS. 1 and 5, the license plate recognition assembly 3 includes a first protective shell 32, and the second camera module 31 is mounted inside the first protective shell 32. Moreover, the lens of the second camera module 31 is located on the side wall of the first protective shell 32.

In an embodiment, a driving mark or leading line (not indicated in the figure) is provided on the fixed surface in the opposite direction of the first direction (X) to guide the vehicle to travel along the first direction (X) and correspond to the optimal shooting angle of the second camera module 31.

In an embodiment, as shown in FIGS. 1, 2, 3, and 5, the tire tread detection device includes a triggering mechanism 4, and the triggering mechanism 4 includes a switch module 41 located within the cavity 10. The main body 1 is provided with a fifth opening 400 in communication with the cavity 10.

In an embodiment, the fifth opening 400, the first opening 101, and the second opening 102 are arranged in intervals along the first direction (X), and the triggering end of the switch module 41 (not indicated in the figure) extends out of the fifth opening 400.

Specifically, when the vehicle reaches the position corresponding to the fifth opening 400, the tire tread area of the tire acts on the triggering end (not marked in the figure) of the switch module 41 to force the triggering end (not marked in the figure), which is then triggered to turn on the power supply; the control assembly 6 controls the laser module 21 and the first camera module 20 to work synchronously. It can be known that the second camera module 31 and the first camera module 20 are not working at the same time, and the second camera module 31 has already started working before the vehicle travels onto the main body 1.

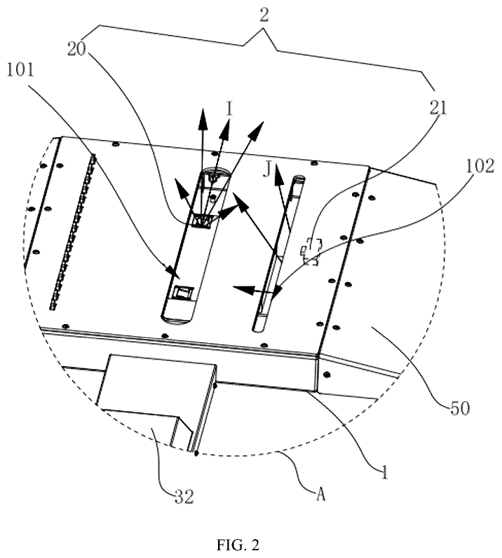

In an embodiment, as shown in FIG. 2, the tire tread detection device further includes a reflective plate 22, the reflective plate 22 is located inside the cavity 10. The reflective plate 22 is used to reflect the laser line (J) emitted by the laser module 21 to illuminate the tire tread area of the tire to be measured.

In an embodiment, the reflective plate 22 is located on the side of the laser module 21 away from or adjacent to the first camera module 20.

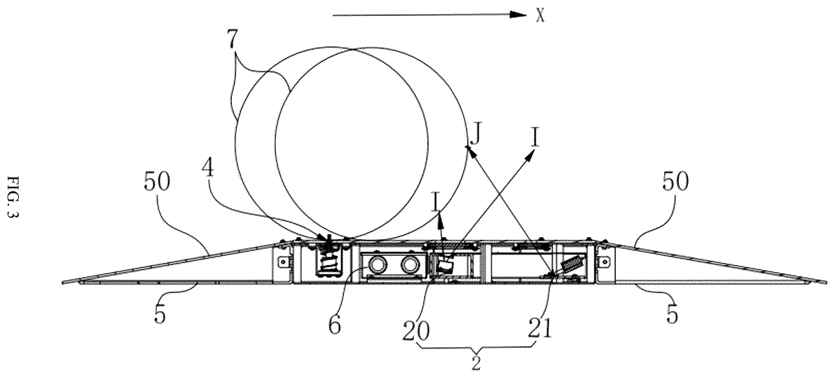

As further shown in FIG. 3, in the embodiment, the reflective plate 22 is located on the side of the laser module 21 adjacent to the first camera module 20, that is, the reflective plate 22 is located between the laser module 21 and the first camera module 20. It can be seen that the laser module 21 is obliquely arranged inside the cavity 10, which can effectively reduce the volume of the cavity 10, that is, the height of the entire device is lowered.

Specifically; when the tire tread detection device of the embodiment is applied, the detection steps are as follows:

The vehicle travels in the first direction (X) from the slope surface 50 to the edge position of the top of the main body 1 (specifically the top of the cavity 10, i.e. the upper cover 11). When the tire tread area contacts the triggering end of the switch module 41 (not marked in the figure), the triggering end will rebound under the force of the tire to trigger the power supply, and then turn on the detection assembly 2.

At this point, the vehicle continues to travel, whether the tire tread area first reaches the range of sight line I of camera of the first camera module 20 or the illumination range of the laser line (J) depends on the distance between the first camera module 20 and the laser module 21, as well as the mounting angle of the first camera module 20 and the laser module 21. It can be temporarily assumed that the tire tread area reaches both the range of sight line I of camera of the first camera module 20 and the illumination range of the laser line (J) at the same time, so as to explain the technical solution of the present application.

As shown in FIG. 3, when the tire tread area 7 reaches the range of sight line I of camera of the first camera module 20, the laser line (J) of laser module 21 passes through the second opening 102 to reach the tire tread area of tire 7 (i.e. the tire tread area corresponding to the second opening 102) to obtain depth data of the tire tread. At the same time, the first camera module 20 captures the tire tread area of illustrative tire 7 through the first opening 101 to obtain tire tread images, and synchronously transmits the tire tread images to the control assembly 6 for recording and analysis.

Specifically, the control assembly 6 combines test image data and depth data for simulated mapping, compares the simulated data with the original image data and automatically determines the absence and cracking of tire treads in the tire tread area of the illustrative tire 7.

Specifically, the laser module 21 is consisted of two parts: emitting laser and receiving returning laser. The emitting laser source of the laser module 21 dynamically scans the surface of illustrative tire 7 (it can be known that the measurement process is completed during vehicle travelling), and obtains distance data by receiving the returned laser part. As the detection is a real-time measurement, a series of continuous values with peak valley distribution are obtained. The control assembly 6 calculates the absolute value of the difference between the maximum peak and minimum valley values of the measurement data, which represents the depth of tire tread of the illustrative tire 7. The conventional techniques involved are not explained in detail here.

In an embodiment, the vehicle travels repeatedly in the first direction (X) and measures multiple times to obtain more comprehensive dynamic data to enhance measurement accuracy.

In an embodiment, the first opening 101 and the second opening 102 are arranged in a long strip shape. Moreover, the length direction of the first opening 101 and the second opening 102 correspond to the width direction of the illustrative tire 7, and the lengths of the first opening 101 and the second opening 102 are greater than or equal to the width dimension of the corresponding tire surface of the illustrative tire 7, so that a single measurement can obtain the maximum range of tire tread information and reduce the number of repeated measurements.

In an embodiment, the number of laser modules 21 and the first camera modules 20 can be one or multiple. In the embodiment, the number of laser module 21 and first camera module 20 can be consistent or inconsistent. The number of laser module 21 and the first camera module 20 can be determined based on the number and width of the illustrative tire 7.

In an embodiment, the laser module 21 in the present application is obliquely arranged towards the first opening 101, and the first camera module 20 is obliquely arranged towards the second opening 102 to obtain a larger range of captured images and depth information. In the embodiment, the tilt angle of the laser module 21 and the first camera module 20 can be selected according to the actual situation.

The tire tread detection device of the present application is easy to operate and avoids the problems of slow measurement speed, high labor investment, and low efficiency caused by manual squatting to collect tire tread data one by one. The convenience of operation is improved, which is conducive to achieving automated operations.

In an embodiment, as shown in FIGS. 4 and 5, the tire tread detection device of the present application further includes a second protective shell 14, and the second protective shell 14 is buckled inside the cavity 10. Specifically, the second protective shell 14 is buckled onto the detection assembly 2 to prevent dust and water damage to the detection assembly. It can be known that there are two openings (not shown) on the second protective shell 14 corresponding to the positions of the first transparent window 112 and the second transparent window 113.

In other embodiments, after the vehicle is driven onto the main body 1, a lifting device (not shown) is mounted on the fixed surface. The lifting device is pushed against the vehicle to push the vehicle in a suspended state, and then the wheels are controlled to spin to complete multiple detection processes to obtain complete tire tread data in the tread area of the tire to be measured.

In other embodiments, the license plate recognition assembly 3 is located on one side of one of the detection assemblies 2 of the device, and the license plate recognition assembly 3 is at a certain height position (not shown).

In other embodiments, the switch module 41 of the device is an infrared sensing device (not shown).

In other embodiments, the main body 1 is provided with a voice broadcast module (not shown), and the voice broadcast module is used to broadcast tire detection results. In the embodiment, the voice broadcast module is mounted on the main body 1 to directly broadcast the tire detection results in voice form, and the car owner can directly obtain the current status of the tire. It should be noted that in the embodiment, the voice broadcast module can select the timbre of the speaker.

According to another aspect of the present application, a tire tread detection system is proposed, which includes the tire tread detection device as described in the above embodiment. The tire detection system includes a display terminal electrically connected to the control assembly 6. After the detection is completed, the detection results are displayed through the display terminal.

The tire detection system of the present application includes the tire tread detection device, the license plate recognition assembly, the detection assembly, the display terminal, and the control assembly. When the vehicle to be measured passes through the main body 1, the license plate information is recognized through the license plate recognition assembly, and the three-dimensional information of the tire tread of the tire to be measured is obtained through the detection assembly. The central processor unit of the control assembly processes the three-dimensional information of the tire tread of the tire to be measured to obtain the tire detection results (whether the tire tread depth is qualified, whether there is a tire eaten, whether there are cracks, and whether the pattern is consistent, etc.), the tire detection results are displayed on the display terminal along with the license plate information. The detection is fast and accurate, which has important practical significance for improving vehicle driving safety and reducing traffic accidents.

The aforementioned embodiments are only preferred embodiments of the present application, and should not be regarded as being limitation to the present application. Any modification, equivalent replacement, improvement, and so on, which are made within the spirit and the principle of the present application, should be included in the protection scope of the present application.

1. A tire tread detection device, comprising:
a main body (1), mounted to a fixed surface, wherein the main body (1) is provided with a cavity (10), a first opening (101), and a second opening (102); the second opening (102) and the first opening (101) are spaced along a first direction (X) and are respectively in communication with the cavity (10);
a detection assembly (2), arranged inside the cavity (10), wherein the detection assembly (2) comprises a first camera module (20) and a laser module (21); the first camera module (20) is configured to capture a tire tread area of a tire to be measured through the first opening (101) to obtain a tire tread image, and a laser line (J) of the laser module (21) passes through the second opening (102) to reach the tire tread area of the tire to be measured to obtain depth data of a tire tread; and
a control assembly (6), wherein the first camera module (20) and the laser module (21) are electrically connected to the control assembly (6), respectively;
wherein the first direction (X) is a forward direction of the tire to be measured corresponding to a vehicle.

2. The tire tread detection device according to claim 1, wherein the tire tread detection device further comprises a reflective plate (22) located within the cavity (10), the reflective plate (22) is configured to reflect the laser line (J) emitted by the laser module (21) to illuminate the tire tread area of the tire to be measured.

3. The tire tread detection device according to claim 2, wherein the reflective plate (22) is located on a side of the laser module (21) away from or adjacent to the first camera module (20).

4. The tire tread detection device according to claim 3, wherein two detection assemblies (2) are provided, and two cavities (10) are provided correspondingly; the two detection assemblies (2) and the two cavities (10) are arranged in one-to-one correspondence, and the two cavities (10) are symmetrically arranged relative to a vertical line of the first direction (X).

5. The tire tread detection device according to claim 4, wherein the main body (1) comprises upper covers (11), lower covers (12), first brackets (110), and second brackets (111); one of the upper covers (11) and one of the lower covers (12) are interlocked to form one of the two cavities (10), each of the upper covers (11) is provided with the first opening (101) and the second opening (102), the first brackets (110) and the second brackets (111) are mounted inside the two cavities (10), each of the first brackets (110) is provided with a first transparent window (112) arranged corresponding to the first opening (101) of each of the upper covers (11), and each of the second brackets (111) is provided with a second transparent window (113) arranged corresponding to the second opening (102) of each of the upper covers (11).

6. The tire tread detection device according to claim 5, wherein the tire tread detection device further comprises:
a license plate recognition assembly (3), wherein an end of the license plate recognition assembly (3) is connected to one of the lower covers (12), and an other end of the license plate recognition assembly (3) is connected to another one of the lower covers (12); the license plate recognition assembly (3) comprises a second camera module (31) configured to identify and record a license plate of the vehicle corresponding to the tire to be measured; and the second camera module (31) is electrically connected to the control assembly (6).

7. The tire tread detection device according to claim 6, wherein a lens of the second camera module (31) is oriented in an opposite direction of the first direction (X) and is located in a spatial area above a horizontal plane.

8. The tire tread detection device according to claim 7, wherein the tire tread detection device comprises triggering mechanisms (4), and each of the triggering mechanisms (4) comprises a switch module (41) located within one of the cavities (10), and the main body is provided with a fifth opening (400) in communication with the one of the cavities (10); the fifth opening (400), the first opening (101), and the second opening (102) are arranged in intervals along the first direction (X), and a triggering end of the switch module (41) extends out of the fifth opening (400).

9. The tire tread detection device according to claim 8, wherein the tire tread detection device further comprises slope frames (5), two ends of each of the lower covers (12) is respectively provided with one slope frame (5), and a cross-sectional shape of a structure formed by two slope frames (5) and the main body (1) is an isosceles trapezoid.

10. A tire tread detection system, comprising a tire tread detection device; wherein the tire tread detection device comprises:
a main body (1), mounted to a fixed surface, wherein the main body (1) is provided with a cavity (10), a first opening (101), and a second opening (102); the second opening (102) and the first opening (101) are spaced along a first direction (X) and are respectively in communication with the cavity (10);
a detection assembly (2), arranged inside the cavity (10), wherein the detection assembly (2) comprises a first camera module (20) and a laser module (21); the first camera module (20) is configured to capture a tire tread area of a tire to be measured through the first opening (101) to obtain a tire tread image, and a laser line (J) of the laser module (21) passes through the second opening (102) to reach the tire tread area of the tire to be measured to obtain depth data of a tire tread; and
a control assembly (6), wherein the first camera module (20) and the laser module (21) are electrically connected to the control assembly (6), respectively;
wherein the first direction (X) is a forward direction of the tire to be measured corresponding to a vehicle; and
wherein the tire detection system comprises a display terminal electrically connected to the control assembly (6).

11. The tire tread detection system according to claim 10, wherein the tire tread detection device further comprises a reflective plate (22) located within the cavity (10), the reflective plate (22) is configured to reflect the laser line (J) emitted by the laser module (21) to illuminate the tire tread area of the tire to be measured.

12. The tire tread detection system according to claim 11, wherein the reflective plate (22) is located on a side of the laser module (21) away from or adjacent to the first camera module (20).

13. The tire tread detection system according to claim 12, wherein two detection assemblies (2) are provided, and two cavities (10) are provided correspondingly; the two detection assemblies (2) and the two cavities (10) are arranged in one-to-one correspondence, and the two cavities (10) are symmetrically arranged relative to a vertical line of the first direction (X).

14. The tire tread detection system according to claim 13, wherein the main body (1) comprises upper covers (11), lower covers (12), first brackets (110), and second brackets (111); one of the upper covers (11) and one of the lower covers (12) are interlocked to form one of the two cavities (10), each of the upper covers (11) is provided with the first opening (101) and the second opening (102), the first brackets (110) and the second brackets (111) are mounted inside the two cavities (10), each of the first brackets (110) is provided with a first transparent window (112) arranged corresponding to the first opening (101) of each of the upper covers (11), and each of the second brackets (111) is provided with a second transparent window (113) arranged corresponding to the second opening (102) of each of the upper covers (11).

15. The tire tread detection system according to claim 14, wherein the tire tread detection device further comprises:
a license plate recognition assembly (3), wherein an end of the license plate recognition assembly (3) is connected to one of the lower covers (12), and an other end of the license plate recognition assembly (3) is connected to another one of the lower covers (12); the license plate recognition assembly (3) comprises a second camera module (31) configured to identify and record a license plate of the vehicle corresponding to the tire to be measured; and the second camera module (31) is electrically connected to the control assembly (6).

16. The tire tread detection system according to claim 15, wherein a lens of the second camera module (31) is oriented in an opposite direction of the first direction (X) and is located in a spatial area above a horizontal plane.

17. The tire tread detection system according to claim 16, wherein the tire tread detection device comprises triggering mechanisms (4), and each of the triggering mechanisms (4) comprises a switch module (41) located within one of the cavities (10), and the main body is provided with a fifth opening (400) in communication with the one of the cavities (10); the fifth opening (400), the first opening (101), and the second opening (102) are arranged in intervals along the first direction (X), and a triggering end of the switch module (41) extends out of the fifth opening (400).

18. The tire tread detection system according to claim 17, wherein the tire tread detection device further comprises slope frames (5), two ends of each of the lower covers (12) is respectively provided with one slope frame (5), and a cross-sectional shape of a structure formed by two slope frames (5) and the main body (1) is an isosceles trapezoid.
